(19) United States
(12) Patent Application Publication
(10) Pub. No.: US 2005/0103072 A1
(43) Pub. Date: May 19, 2005

(54) Lock with roses having pairs of ledges of different lengths to cope with different keys

(75) Inventor: Miko Lee, Taipei Hsien (TW)

Correspondence Address: VENABLE, BAETJER, HOWARD AND CIVILETTI, LLP, P.O. BOX 34385, WASHINGTON, DC, 20043-9998, US

(73) Assignee: UFO INTERNATIONAL CORP., Taipei Hsien (TW)

(21) Appl. No.: 10/920,227

(22) Filed: Aug. 18, 2004

(30) Foreign Application Priority Data
Nov. 13, 2003 (TW) 092131782

(51) Int. Cl. E05B 29/04

(52) U.S. Cl. 70/492

(57) ABSTRACT

A lock includes a housing, a rose assembly movably received in the housing and having multiple roses rotatably received in the housing and each rose having a pair of ledges oppositely formed on and extending outward from a periphery defining a through hole in the rose and a core securely received in the housing and having a keyhole to allow a key having steps formed thereon to extend therethrough and a controlling slot defined through the core. Changing the length of either one of the pair of ledges of the rose enables different keys to activate the lock.

### BACKGROUND OF THE INVENTION

1. Field of the Invention

The present invention relates to a lock, and more particularly to a lock provided with multiple roses movably received in the casing of the lock and each having a pair of ledges of variable lengths so that different keys with steps corresponding to the pair of ledges are able to activate the lock.

2. Description of Related Art

It is common for places where people congregate, such as factories, sports halls and so on to have a locker room whereby those people may leave some of their belongings in a safe manner in order to go about their business unencumbered. When using their locker rooms, those people are usually equipped with a key corresponding to a specific locker such that the possessions may be accessed quickly and conveniently, yet the locker remains a private and safe depository. However, the users may lose their keys and under such a condition, there is no way to use that locker anymore. It is also known for some people to abuse the storage facility by taking the key away with them even when they are no longer entitled to use the locker. Some people may store illegal items in the lockers to prevent policing authorities from detecting them. Responsible people, such as janitors may periodically have to clear out the locker room, and this is particularly so if too many of the lockers have become unusable due to lost keys. The janitor normally has a “master-key” to activate all the lockers even though some of the lockers are locked but when the lock itself is damaged or destroyed, not even the janitor is able to activate the lock. Therefore, new locks together with new keys have to be purchased, the respective existing locks have to be removed, and the new locks have to be mounted on the respective lockers. As a consequence of losing the keys, considerable expenses are incurred through purchase of locks and in particular, the labor costs involved in the replacing of the locks. Furthermore, there is also the incalculable cost to people who may be denied access to important possessions through loss of keys.

To overcome the shortcomings, the present invention tends to provide an improved lock to mitigate the aforementioned problems.

### SUMMARY OF THE INVENTION

The primary objective of the present invention is to provide an improved lock with roses each having a pair of ledges of variable lengths such that not only is a master key able to activate the lock, different secondary keys are able to activate the same lock after the sequence of the roses are rearranged.

Another objective of the present invention is to provide a master key hiving steps of different lengths to correspond to the ledges of the roses so that the master key is able to activate the lock.

Still another objective of the present invention is to provide a secondary key having secondary steps of different lengths to correspond to the ledges of the roses so that the secondary keys are able to activate the lock after the sequence of the roses is rearranged.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the lock of the first preferred embodiment of the present invention;

FIG. 2 is a schematic cross sectional view showing that a master key is to be inserted into the lock of the present invention;

FIG. 3 is a schematic view showing that the master key is received in the lock of the present invention;

FIG. 4 is an exploded perspective view of the lock, wherein a secondary key is employed to cope with the sequence of the roses;

FIG. 5 is a schematic view showing that the secondary key is to be inserted into the assembled lock of the present invention;

FIG. 6 is a cross sectional schematic view showing that the secondary key is received in the lock of the present invention; and

FIG. 7 is a schematic view showing a different secondary key is to be inserted into the lock of the present invention.

### DETAILED DESCRIPTION OF THE PREFERRED EMBODIMENT

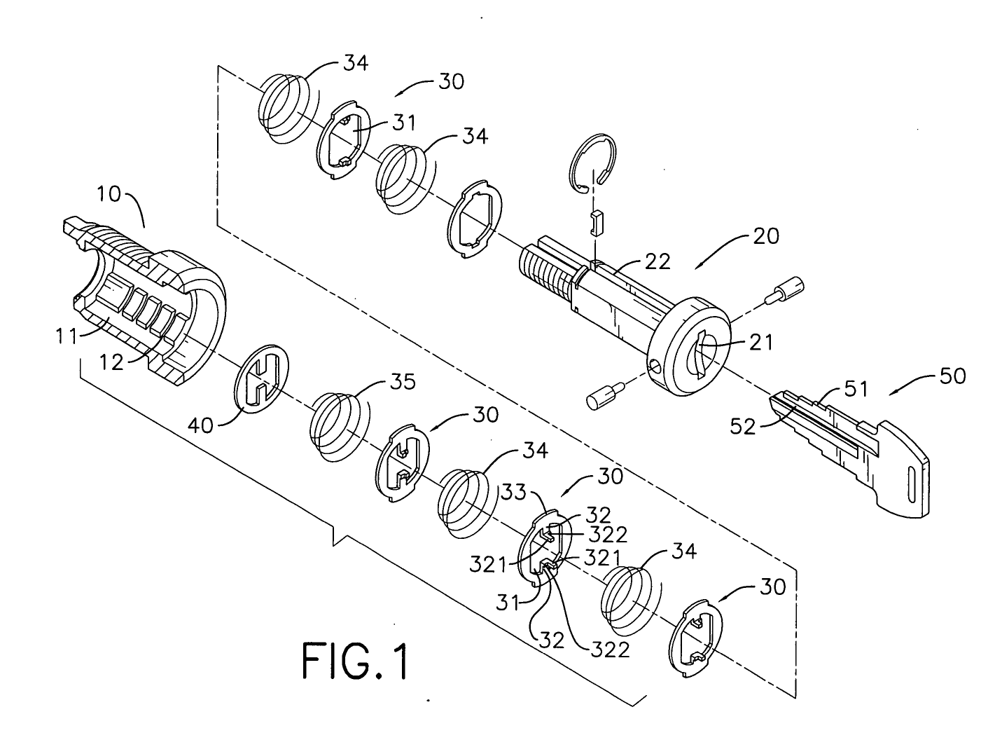

With reference to FIG. 1, the lock in accordance with the present invention includes a cylindrical, hollow housing (10), a core (20), a rose assembly (30) and a positioning disk (40). A master key (50) is also provided to cope with the arrangement of the rose assembly (30).

The housing (10) has multiple passages (11) axially defined in an inner face of the housing (10) and multiple radial grooves (12) radially defined in the inner face of the housing (10).

The core (20) has a keyhole (21) to correspond to the master key (50) and a controlling slot (22) radially defined through the core (20).

The key (50) has multiple pairs of steps (51) formed on opposite sides of the master key (50).

The rose assembly (30) has multiple roses (31) and springs (34). Each spring (34) is sandwiched between a respective two of the roses (31) except the last spring (34) which is sandwiched between one of the roses (31) and the positioning disk (40). Each rose (31) has a pair of ledges (32) oppositely defined in a periphery defining a through hole (not numbered) of the rose (31) and each ledge (32) has an abutting end (321) and a cutout (322) defined adjacent to the abutting end (321). The positioning disk (40) is received in the housing (10) to position the rose assembly (30) inside the housing (10). Furthermore, it is noted that in addition to the steps (51) which correspond to the cutouts (322) of the ledges (32), the master key (50) has a path (52) formed adjacent to the steps (51) to correspond to the abutting ends (321).

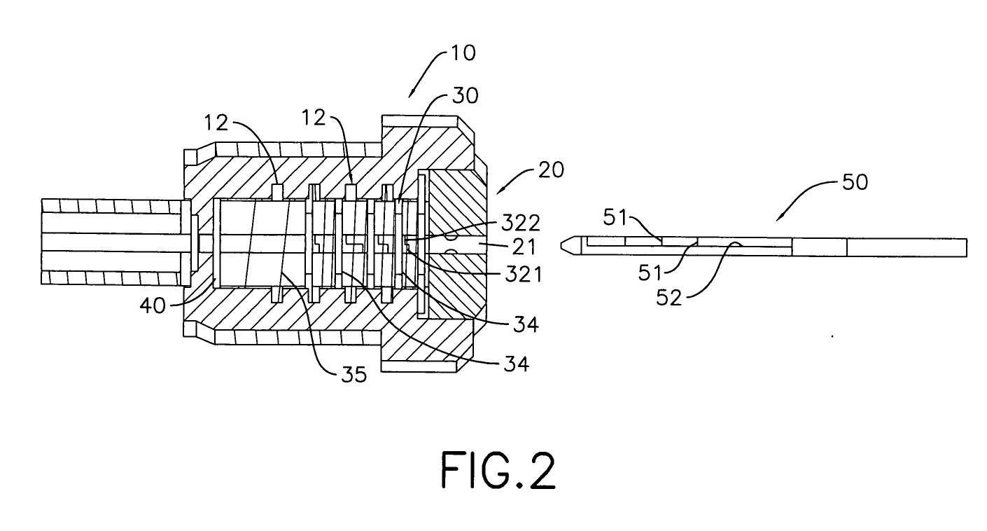

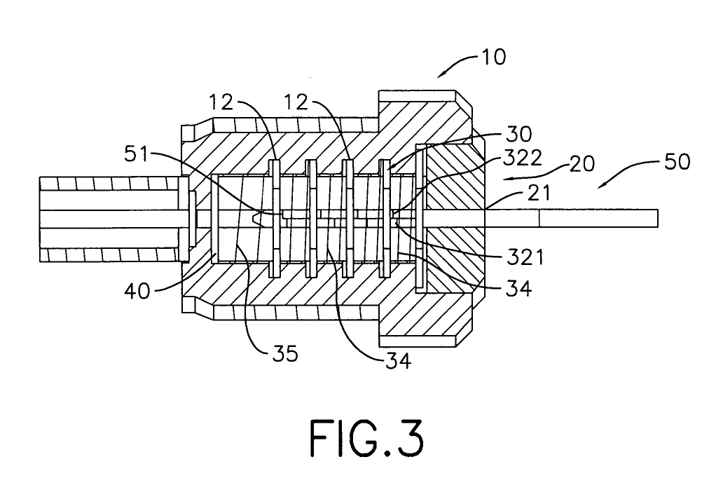

With reference to FIGS. 2 and 3, it is noted that after the lock of the present invention is assembled, the ledges (32) of the roses (31) extend into the controlling slot (22) of the core (20) and each rose (31) is spaced by the radial grooves (12). Further details of the lock assembly are omitted in that the structural relationship between components is conventional. The focus of the invention tends to introduce an idea wherein the change of length of the ledges (32) is able to allow the lock to cope with different keys.

After the master key (50) is inserted into the keyhole (21), the steps (51) abut side faces of the cutouts (322) of each one of the roses (31) to allow the abutting ends (321) to engage with a bottom face of the path (52). Then rotation of the master key (50) is able to drive the roses (31) to rotate inside the housing (10), which activates the lock.

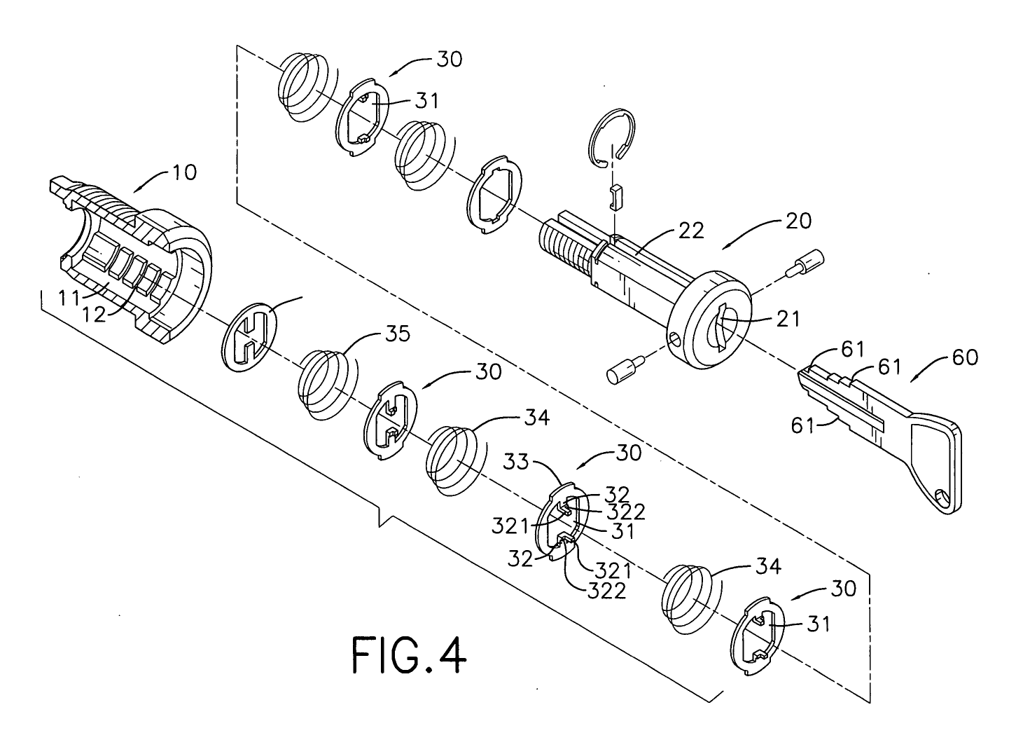

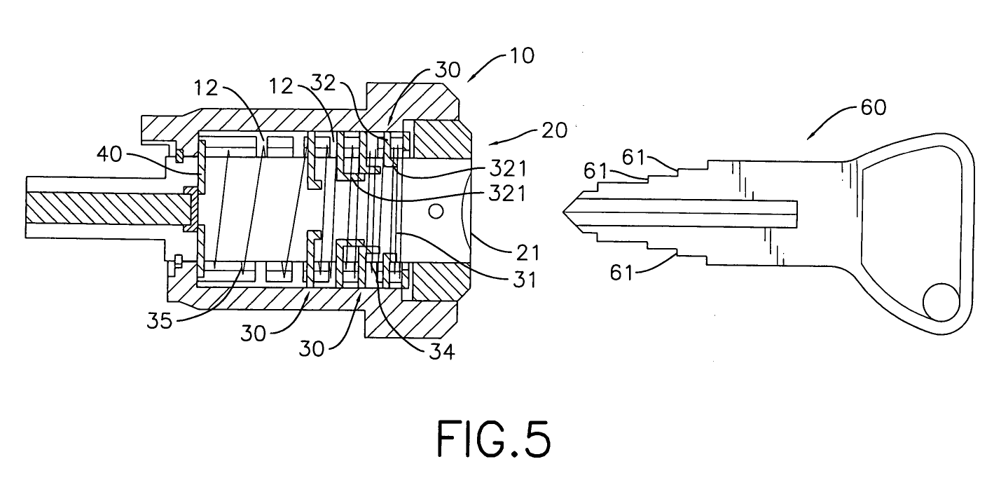

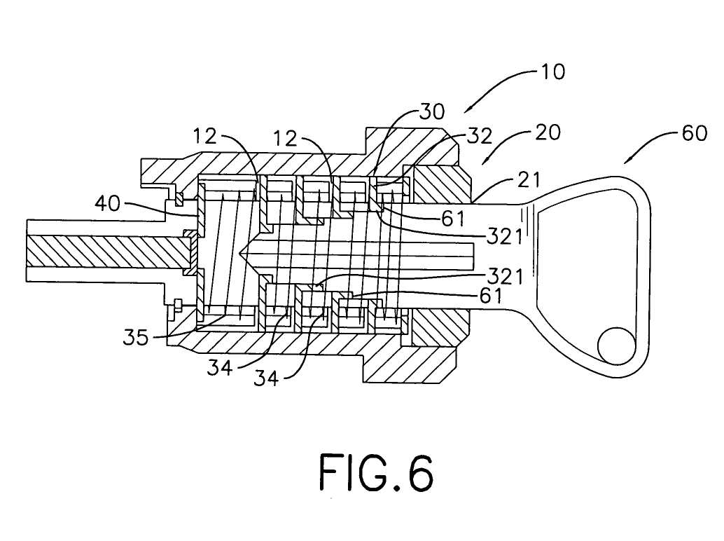

With reference to FIGS. 4, 5 and 6, it is noted that when a secondary key (60) having only steps (61) formed thereon is employed, extension of the secondary key (60) into the keyhole (21) allows the steps (61) to abut the side faces of the abutting ends (321) such that rotation of the secondary key (60) is able to activate the lock.

From the foregoing description, it is to be noted that each pair of ledges (32) may have different lengths such that distance between two adjacent steps (51,61) are different so as to correspond to the lengths of the lengths of the ledges (32).

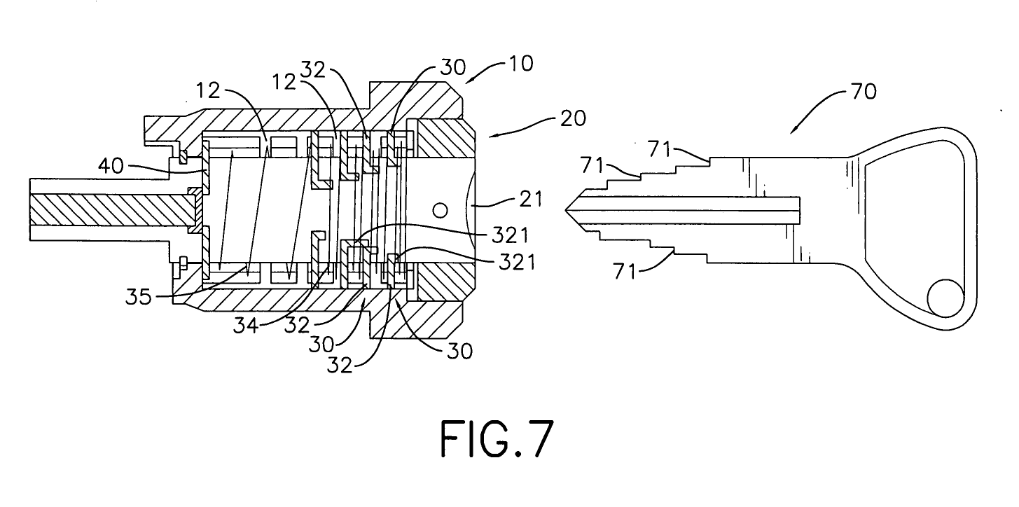

With reference to FIG. 7, a further embodiment of the lock is shown and each rose (31) has only abutting ends (321) formed on distal ends of the pairs of the ledges (32) such that only a secondary key (70) with steps (71) formed thereon is able to activate the lock of the present invention. In summary, it is noted from the description above that when the pair of ledges (32) is equipped with cutouts (322) and abutting ends (321), there is a master key (50) and a secondary key (60) to activate the lock. When the pair of ledges (32) is equipped with only abutting ends (321), only a secondary key (70) is able to activate the lock. Furthermore, as the variable lengths of the ledges (32) and different arrangement of the roses (31), the distances between two adjacent steps (51,61,71) of both the master key and secondary keys (60,70) are different. That is, the distance between two adjacent steps of the key to activate the lock is determined by the length of the ledges of the rose.

With the variation of the lengths of the ledges, the user is able to use the lock in different locations. The lock with both the abutting ends (321) and the cutouts (322) is able to be applied in public areas, such as a changing room, a locker room etc, such that authorized personnel may still have access to unlock the lock. The lock with only the abutting ends (321) may be applied to private locations such as a temporary safe so that only the person with the correct key has the access to activate the lock. Still, by changing the lengths of the ledges (32), the manufacturer is able to save a lot of cost by duplicating the lock components but still managing to achieve safety requirements.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. In a lock having a housing, a rose assembly movably received in the housing and having multiple roses rotatably received in the housing and each rose having a pair of ledges oppositely formed on and extending outward from a periphery defining a through hole in the rose and a core securely received in the housing and having a keyhole to allow a key having steps formed thereon to extend therethrough and a controlling slot defined through the core, wherein the improvement comprises:
one ledge having a length different from a length of the other ledge of the pair of roses.

2. The lock as claimed in claim 1, wherein each ledge has an abutting end formed on a distal end of the ledge and a cutout defined adjacent to the abutting end, the key has a path defined adjacent to the steps such that after the key is inserted into the keyhole, the abutting ends engage with a bottom face defining the path and the steps of the key engage with side faces of the cutouts thereby rotation of the key is able to activate the lock.

3. The lock as claimed in claim 2, wherein a distance between two adjacent steps of the key is determined by the lengths of the pair of ledges of the roses.
